(19) United States
(12) Patent Application Publication
(10) Pub. No.: US 2015/0192694 A1
(43) Pub. Date: Jul. 9, 2015

(54) Robust Well Log Sharpening With Unknown Tool Response Function

(71) Applicant: Schlumberger Technology Corporation, Sugar Land, TX (US)

(72) Inventors: George A. Bordakov, Richmond, TX (US); Markus V. Kliegl, Princeton, NJ (US); Jaideva C. Goswami, Sugar Land, TX (US)

(73) Assignee: Schlumberger Technology Corporation, Sugar Land, TX (US)

(21) Appl. No.: 14/151,687

(22) Filed: Jan. 9, 2014

(51) Int. Cl. G01V 99/00

(52) U.S. Cl. CPC G01V 99/00

(57) ABSTRACT

A method for enhancing axial resolution of a well logging instrument includes classifying a formation into a plurality of single well log measurement value zones to generate a squared well log. A response function of a well logging instrument is decomposed into a plurality of wavelets. The wavelets are convolved with the squared well log to generate a simulated tool response. The simulated tool response is compared to a measured tool response in the formation. The decomposing is repeated with different coefficients for each wavelet and the convolving is repeated until a mismatch between the simulated tool response and the measured tool response falls below a measurement uncertainty of the well logging instrument.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND

The present disclosure relates generally to the field of well log interpretation. More specifically, the disclosure relates to matching axial resolution of different types of well log measurements made within the same wellbore.

This section is intended to introduce the reader to various aspects of art that may be related to various aspects of the subject matter described and/or claimed below. This discussion is believed to be helpful in providing the reader with background information to facilitate a better understanding of the various aspects of the present disclosure. Accordingly, it should be understood that these statements are to be read in this light, not as admissions of prior art.

Well logging instruments may include an energy source, and one or more detectors disposed axially spaced apart from the source along an instrument housing (or drill collar). The source imparts energy into the wellbore and surrounding formations through which the wellbore is drilled. The one or more detectors detect energy having been modified by interaction with the materials in the wellbore and the surrounding formations.

Different types of well logging instruments may have different axial resolution. The basic ideas of “sharpening” logs through finding per-facies measurement values by applying convolution filters to the facies-based well logs and then matching these results with measurements is known in the art. See, for example, David Allen, Tom Barber, Charles Flaum, Jim Hemingway, Barbara Anderson, Serge des Ligneris, Advances in High-Resolution Logging, Schlumberger Technical Review, 1988 and O. Serra, M. Andreani, Thin Beds: A Guide to Interpretation of Thinly Layered Reservoirs, Schlumberger, M-090251, SMP, 1991.

U.S. patents related to these ideas include U.S. Pat. No. 5,461,562 issued to Tabanou et al. and U.S. Pat. No. 6,963,803 issued to Heliot et al. Methods disclosed in the foregoing patents, for example, have been implemented as software applications in a suite sold under the trademark GEOFRAME, which us a mark of Schlumberger Technology Corporation. Two particular software applications include ones sold under the trademarks SHARP and SHARPLITE (also marks of Schlumberger Technology Corporation) with the latter application allowing automatic matching.

Considerable progress has been made in developing various classification applications for the industry and several powerful applications are available now in Schlumberger commercial software such as software sold under the trademark IPSOM (also a mark of Schlumberger Technology Corporation) and Heterogeneous Rock Analysis (HRA) in Techlog. See, for example, Mark Skalinski, Stephanie Gottlib-Zeh, Brian Moss, Defining and Predicting Rock Types in Carbonates-an Integrated Approach using Core and Log Data in Tengiz Field, SPWLA 46th Annual Logging Symposium, 2005 and Vikas Jain, Chanh Cao Minh, Nick Heaton, Paolo Ferraris, Luca Ortenzi, Mauro Tones Ribeiro, Characterization of Underlying Pore and Fluid Structure Using Factor Analysis on NMR Data, SPWLA 54th Annual Symposium in New Orleans, La., Jun. 22-26, 2013.

### SUMMARY

A summary of certain embodiments disclosed herein is set forth below. It should be understood that these aspects are presented merely to provide the reader with a brief summary of certain embodiments and that these aspects are not intended to limit the scope of this disclosure. Indeed, this disclosure may encompass a variety of aspects that may not be set forth in this section.

In accordance with one aspect of the disclosure, a method for enhancing axial resolution of a well logging instrument includes classifying a formation into a plurality of single well log measurement value zones to generate a squared well log. A response function of a well logging instrument is decomposed into one or more wavelets. The wavelets are convolved with the squared well log to generate a simulated tool response. The simulated tool response is compared to a measured tool response in the formation. The decomposing is repeated with different coefficients for each wavelet and the convolving is repeated until a mismatch between the simulated tool response and the measured tool response falls below a measurement uncertainty of the well logging instrument.

In accordance with another aspect of the disclosure, a method for well logging includes moving a well logging instrument along a wellbore drilled through subsurface formations and acquiring measurements of at least one petrophysical parameter using the well logging instrument, the well logging instrument having an axial measurement resolution lower than a number of separate, single petrophysical parameter value zones in the subsurface formations. The method further includes, in a computer, classifying the subsurface formations into a plurality of single well log measurement value zones to generate a squared well log, decomposing a response function of the well logging instrument into a one or more wavelets, convolving the wavelets with the squared well log to generate a simulated tool response, comparing the simulated tool response to a measured tool response in the formation, and repeating the decomposing with different coefficients for each wavelet and repeating the convolving until a mismatch between the simulated tool response and the measured tool response falls below a measurement uncertainty of the well logging instrument.

Other aspects and advantages of methods according to the present disclosure will be apparent from the description and claims that follow.

### BRIEF DESCRIPTION OF THE DRAWINGS

The present disclosure is best understood from the following detailed description when read with the accompanying figures. It is emphasized that, in accordance with standard practice in the industry, various features are not necessarily drawn to scale. In fact, the dimensions of various features may be arbitrarily increased or recued for clarify of discussion.

FIG. 1 shows a flow chart of an example embodiment of a process according to the present disclosure.

FIG. 2A shows an example wireline conveyed multi-axial electromagnetic well logging instrument disposed in a wellbore drilled through subsurface formations.

FIG. 2B shows an example well logging instrument system that may be used during wellbore drilling.

FIG. 3 shows an example computer system.

### DETAILED DESCRIPTION

One or more specific embodiments of the present disclosure are described below. These embodiments are merely examples of the presently disclosed techniques. Additionally, in an effort to provide a concise description of these embodiments, all features of an actual implementation may not be described in the specification. It should be appreciated that in the development of any such implementation, as in any engineering or design project, numerous implementation-specific decisions are made to achieve the developers' specific goals, such as compliance with system-related and business-related constraints, which may vary from one implementation to another. Moreover, it should be appreciated that such development efforts might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The embodiments discussed below are intended to be examples that are illustrative in nature and should not be construed to mean that the specific embodiments described herein are necessarily preferential in nature. Additionally, it should be understood that references to “one embodiment” or “an embodiment” within the present disclosure are not to be interpreted as excluding the existence of additional embodiments that also incorporate the recited features.

Methods according to the present disclosure are proposed to improve matching of well log measurements made by instruments having various axial resolutions. Methods according to the present disclosure are based on two fundamental assumptions.

The first assumption is that an interval or subsurface formation of interest can be classified so that that each of the classes has the same measurement values either for the entire interval or formation of interest or within one or more zones when the interval is divided into several zones. Therefore a “true” measurement log represents a “squared” well log constructed as one value per classification at each depth along each zone in which well log measurements are made.

The second assumption is that the measurements actually made by the one or more well logging instruments are a convolution of the above described squared “true” measurement log with a tool response function unique to each well logging tool. The tool response function is a property of the particular well logging tool rather than the formations being measured.

Classes can represent, e.g., geological facies or petrophysical (i.e., well log measurement) properties within the particular zone or interval or some combination of geological facies and petrophysical properties. Also, in convolution different types of averaging may be applied depending on the nature of the particular well log measurements, e.g., for neutron and nuclear magnetic resonance (NMR) derived porosity and acoustic slowness, arithmetic averaging may be used, while for electrical resistivity, photoelectric factor and acoustic velocity, harmonic averaging may be used. The SHARP software library referred to in the Background section herein enables finding per-class measurement values that may provide a best match with the measured log. Thus all the different well log measurements are equalized in axial resolution to the resolution of the classification and are therefore resolution matched. Logically, classification may be based on higher resolution logs (preferably to that of the highest resolution well log measurements available) and therefore resolution matched measurements from tools having lower axial resolution are “sharpened”, that is, their axial resolution is enhanced.

1. Significance of the Classification

A premise of any classification is that objects belonging to the same class are similar while objects belonging to different classes are dissimilar. In classification of formations evaluated by well logging instruments, such premise leads to the conclusion that the first fundamental assumption of the above noted SHARP software should be generally applicable and therefore the whole approach is applicable if the second assumption is true, i.e., that the actual from any tool represent a convolution of a tool response function with a “squared” log. The second assumption is true for a wide variety of well logging tools, including without limitation, neutron tools, gamma-gamma density tools, NMR tools, acoustic tools and some resistivity tools. The foregoing makes an overall approach according to the present disclosure feasible in many subsurface formations.

The intent of a particular classification may be different. It may be intended to identify different geological facies. It may also be used just to identify different ranges of the measurements of interest. For example, in sand/shale formations, most well log measurements essential for volumetric analysis are primarily governed by porosity (fractional volume of pore space) in the sandstone and the fractional volume of clay (shale). Synthetic resistivity measurements made from wellbore wall images (e.g., such as made using electrical microresistivity measurements) and dielectric logs (cationic exchange capacity or just apparent conductivity) represent high resolution logs independently reflecting, e.g., porosity and fractional volume of clay. Therefore a classification made using synthetic resistivity and dielectric measurements (and sometimes even just using one of the foregoing) may be used to sharpen textural or even induction and laterolog resistivity measurements. This type of classification may not necessarily reflect any geological facies and may be purely petrophysical (i.e., related only to the measurements themselves). For wellbore completion design in certain types of subsurface formation reservoirs, the well log measurements used to sharpen response may be primarily acoustic logs and any higher resolution logs reflecting mineralogy (rock mineral composition), porosity and fluid composition (i.e., fluid in the pore spaces of the formation), and therefore rock mechanical properties may be used for classification for sharpening.

It may also be advantageous to combine geological classification with petrophysical classification, if the same geological facies may have different measurements of interest. Ultimately the SHARP software classification approach as further developed according to the present disclosure may provide the capability to validate a classification to the particular measurement and tool to refine and revise the classification because any mismatch between measured logs and reconstructed logs can be used as input into subsequent classification(s).

Various log quality problems such as depth mismatch, borehole washouts and tool failures may produce erroneous classification and therefore erroneous sharpening results. This disclosure provides a method which is believed to be robust enough to withstand such failures even in the case when they occur in more than a quarter of an interval of interest.

2. Significance of the Tool Response Functions

The second fundamental assumption used in the SHARP software is that of convolution, as explained above. Convolution may raise concerns related to the fact that the details of any particular tool response function may be unknown. Such may be true especially in the case of the measurement of interest being a result of some inversion or other substantial data processing, especially when the inversion or other processing is derived from measurements made by several different types of logging tools. Such processing may make it difficult to relate an individual tool response function to the particular individual tool design features. The latter is particularly significant if one attempts to sharpen results of well log data processing using, for example, software sold under the trademark ELAN, which is a trademark of Schlumberger Technology Corporation. ELAN software may provide as output porosity, bound water saturation or some specifically constructed log which by design may fit into convolution but are not the result of particular tool measurements such as pseudo-slowness logs. Methods according to the present disclosure are intended to determine a higher resolution log when the individual tool response function is unknown. The present techniques may be used to control tool response quality based on actual recorded well log results.

The sharpening algorithm in the SHARP software is based on the minimization of the cost function:

C=∥Σₜ₌₁^{M}T(V^{l}) b̅^{l}−T( w̅)∥+P( V̅), b̅^{l}= ƒ̅ [symbol] χ̅^{l} (1)

to find per-class measurement values V̅=[V^{l}, l=1, . . . M] providing the best match with possible restrictions on their values. w̅ in Eq. (1) is the vector representing lower resolution well log data to be resolution-matched, b̅^{l} is a convolution of the tool response function ƒ̅ with χ̅^{l}, X̅^{l} is a membership function of the class l in the input classification, c̅, M is the number of classes in the classification c̅, ∥ ∥ designates the L² norm, P( V̅) is a penalty term expressing the possibility of imposing restrictions on values V^{l} and T is a transform corresponding to the averaging type (arithmetic: T(x)=x, harmonic: T(x)=1/x, geometric: T(x)=log x). In methods according to the present disclosure, two extensions to the foregoing minimization may be used.

First, perform a wavelet decomposition of the tool response function ƒ̅=Σⱼ₌₁^{L}αⱼ ζ̅_{J} (see Goswami, J. C. and A. K. Chan, 2011, Fundamentals of Wavelets: Theory, Algorithms, and Applications, John Wiley & Sons, New Jersey, 2nd edition) and consider αⱼ as unknown coefficients that have to satisfy the condition that the sum of the tool response function coefficients is 1 (unity).

Second, change the L² norm ∥ū∥ of a vector ū=[uⁱ, i=1, . . . N] into a more generic function [symbol] (ū)=Σᵢ₌₁^{N} [symbol] [symbol] (uⁱ) which does not increase as quickly as the L² norm with large values of v̅.

Introducing convolutions of wavelets with membership functions χ̅^{l} as g̅_̅{̅J̅}̅^̅{̅l̅}̅= ζ̅_{J} [symbol] χ̅^{l} one may replace the original minimization problem of Eq. (1) with the problem of minimization of the following cost function:

$$C = ℂ [ {\sum }_{l = 1}^{M} {\sum }_{j = 1}^{L} T ( {V}^{l} ) {α}_{j} \overline{{g}_{j}^{l}} - T ( \overline{w} ) ] + P ( \overline{V} ) , \\ ℂ ( \overline{u} = [ {u}^{i} , i = 1 , … N ] ) = {\sum }_{i = 1}^{N} 𝒞 ( {u}^{i } ) \qquad ( 2 )$$

with the conditions Σⱼ₌₁^{L}αⱼM₀( ζ̅_{J})=1 (here M₀( ζ̅_{J}) designates the zero-th moment of the wavelet ζ̅_{J}).

Two possible approaches may include that both V̅=[V^{l}, l=1, . . . M] and αⱼ, j=1, . . . L are variables and minimization of the cost function in Eq. 2 may determine both the tool response function and the sharpened log; or only V̅=[V^{l}, l=1, . . . M] are variables and one only calculates a robust finding of V̅.

One may also use the same restrictions on V̅ and penalties that are used in the SHARP software and generate a sharpened log after minimization as performed using the SHARP software. The estimated tool response function is given by the expression ƒ̅=Σⱼ₌₁^{L}αⱼ ζ̅_{J} and additional penalties or restrictions may be imposed on the coefficients αⱼ to satisfy such requirements as non-negativity or symmetry of the tool response function about a center of axial response. Any available optimization library (commercial, open source) can be used to find a solution to the minimization of the cost function in Eq. 2.

There are two details that may be considered while implementing the above approach:

3. Choice of Basis for Wavelet Decomposition and Level of Decomposition

Several families of available wavelets were tested (including Biorthogonal, Coiflets, Daubechies, Reverse Biorthogonal, Symlets, Orthogonal and Semi-Orthogonal) with different levels of decomposition. Reverse biorthogonal 2.6 and sometimes Daubechies 5 with 3-7 levels of decomposition when tested provided fast and accurate results in the majority of cases, however other wavelets and levels of decomposition can also be used. The user may find a suitable level of decomposition by first choosing a relatively large one and then reducing it until the match is still acceptable. A characteristic that must be specified is a minimal tool response function width (i.e., an axial distance for the tool response function). However such tool response function width is usually known a-priori based on the tool resolution. If there is no such prior knowledge of the minimal tool response function width, a fairly large minimal length may be given at first to obtain an initial estimate and then adjusted downward based on the initial estimate to obtain a more refined estimate.

4. Choice of the Norm

[symbol]

The L² norm used in resolution matching known in the art assumes [symbol] [symbol] (x)=x². That is easiest to minimize but may be susceptible to outliers (see Peter. J. Huber, Robust Statistics, John Wiley & Sons, 1981). The L¹ norm that assumes [symbol] [symbol] (x)=|x| provides greater stability with respect to outliers but may be difficult to minimize. Generally the function [symbol] [symbol] (x) must be non-negative, smooth, has only one minimum at x=0, monotonically decreasing at x<0 and increasing at x>0. It is preferable to choose such function that behaves as x² for small x and as |x| or even |x|^{β}, 0<β<1 for large |x|. The function used may be described as a modified Lp norm. Such norm comprises a smooth (having at least two continuous derivatives) function having a value asymptotically equal to an absolute value of the mismatch in the power of p that is greater than 0 but not greater than 1 for large values of mismatch (i.e., exceeding a selected difference from zero) and asymptotically equal to a square of the mismatch for small values of the mismatch (i.e., being less than the selected difference). In testing various norms, several functions were evaluated and the following is believed to provide acceptable results:

$$𝒞 ( x ) = ɛ [ \sqrt{1 + {( \frac{x}{ɛ} )}^{2}} - 1 ] , ɛ > 0 \qquad ( 3 )$$

[symbol]

[symbol]

(x) may be defined by equation (3) with the small parameter ∈ of about 0.01. Such [symbol] [symbol] (x) is a smooth function that has continuous derivatives of all orders. For large [symbol] [symbol] (x)≈|x|I, while for small x around the interval

$$[ - ɛ , ɛ ] 𝒞 ( x ) = \frac{{x}^{2}}{2 ɛ} + O ( {ɛ}^{2} ) \approx \frac{{x}^{2}}{2 ɛ} .$$

The meaning of the small parameter ∈ is the range of x where [symbol] [symbol] (x) behaves approximately as

X².

Decreasing the parameter ∈ improves robustness, but makes optimization more difficult. It is recommend using ∈ which is about 0.01-0.02 of the median value of the vector T( w̅), since it was determined during testing that decreasing ∈ more does not provide a discernible robustness improvement.

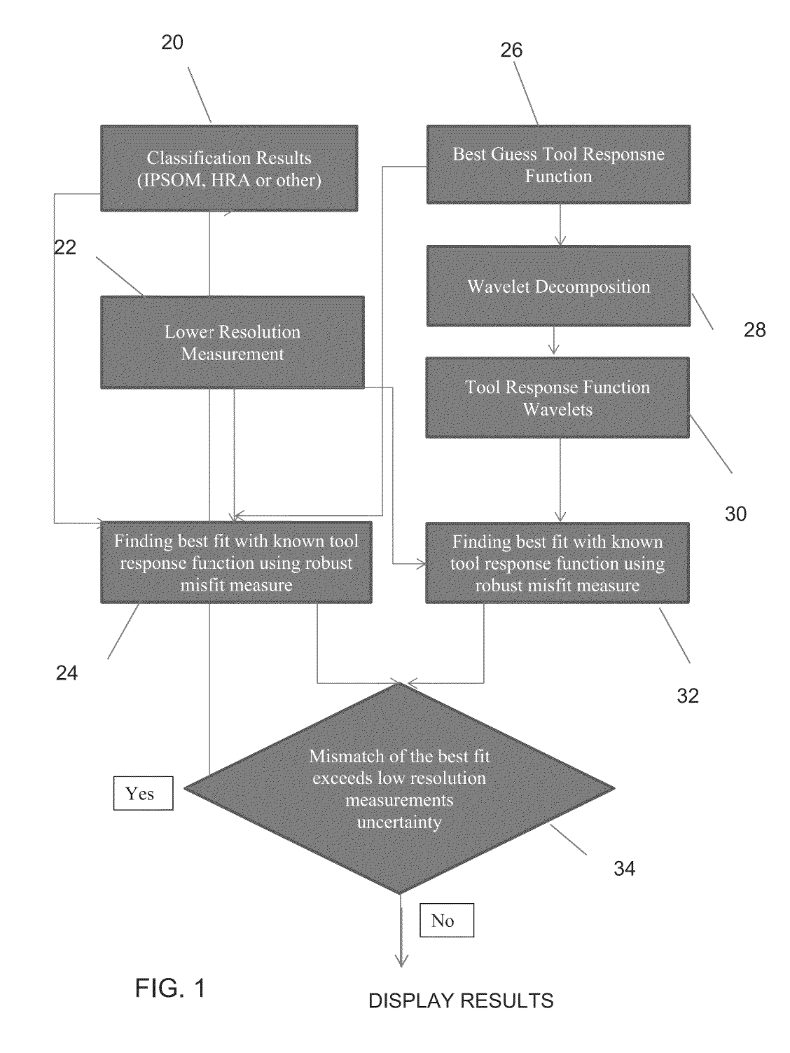

FIG. 1 shows a flow chart of an example implementation of resolution sharpening as explained above. At 22, relatively low axial resolution measurements may be made through one or more formations of interest in a wellbore. At 20, the formations may be classified using, for example, higher axial resolution well log measurements or other data having higher axial resolution than the measurements to be matched. At 24, if the tool response function is known, a best fit of the classified measurements at 22 convolved with the tool function to the actual measurements is made. At 34, if the mismatch between the best fit and the actual measurements exceeds the measurement uncertainty of the low resolution measurements, the classification 20 may be remade with different number of classes, different input measurements, different weights of input measurements or different other parameters specific to a particular classification method, with results of the remade classification used again in 24, until the mismatch at 34 is at most equal to the measurement uncertainty.

At 26, where the tool response function is not known a priori, an initial estimate of estimate of the tool response function may be generated. At 28, the initial estimate of the tool response function may be wavelet decomposed, as explained above. At 30, the tool response function wavelets may be used to generate a simulated tool response to the classified formations. At 32, a best fit of the simulated tool response using the tool response function wavelets to the classified formations is determined. Again, at 34, if the best fit mismatch exceeds the uncertainty of the low resolution measurement, the process may return to 20 for reclassification and the initial estimate at of tool response function at 26 may be adjusted, and the wavelet decomposition 28, simulated tool response at 30 and finding the best fit may be repeated until the mismatch is at most equal to the measurement uncertainty. For both of the above procedures, the results may then be displayed and/or recorded.

In some implementations, the tool response function determined as explained above may be used to monitor tool performance. In one example, the final determined tool response function may be monitored over time. If the determined tool response function deviates from the initially determined tool response function by a selected threshold value (e.g., the coefficients change by a predetermined amount), then the well logging instrument may be removed from service for further evaluation and/or repairs. In another example, the well logging instrument may be used within one or more known formations or simulated formations (e.g., a test tank, test block or similar reference device having known petrophysical properties). The tool response function determined as explained above may be compared to a reference standard tool response function in the known formations or simulated formations. If the determined tool response function deviates from the reference standard tool response function by a predetermined threshold amount, as explained above (e.g., the coefficients), the well logging instrument may be removed from service for evaluation and/or repairs.

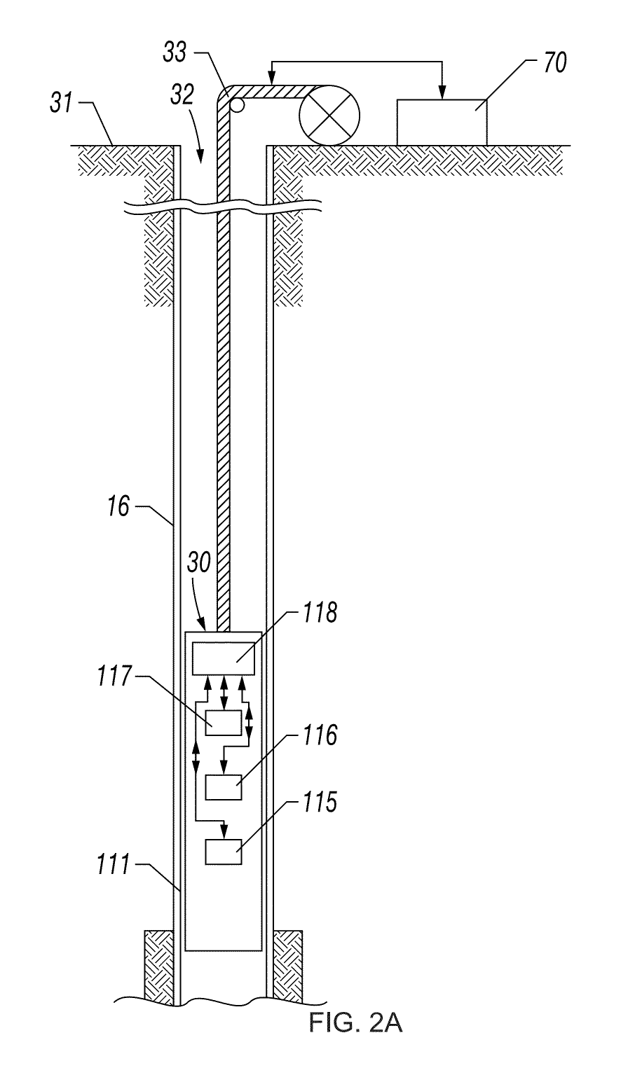

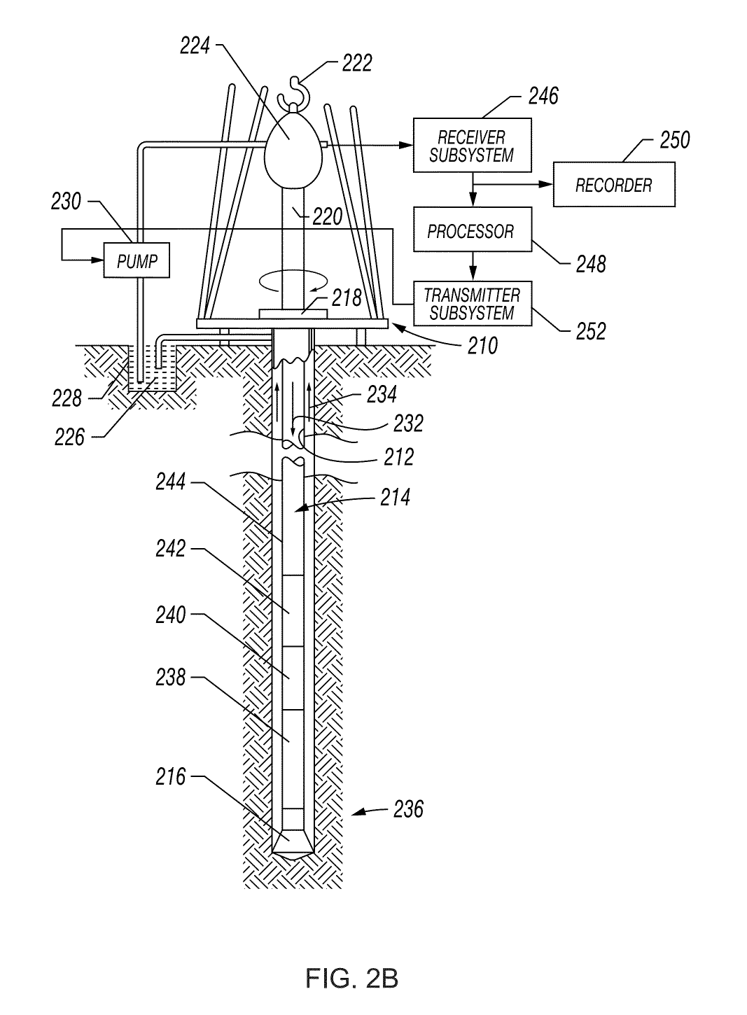

FIG. 2A shows an example well logging instrument 30. The measurement components of the instrument 30 may be disposed in a housing 111 shaped and sealed to be moved along the interior of a wellbore 32. The instrument housing 111 may contain at least one energy source 115, and two or detectors 116, 117 each disposed at different axial spacings from the source 115. The source 115, when activated, may emit any form of energy known to be used in well logging, for example and without limitation, electromagnetic energy, acoustic energy and radiation. Shielding (not shown) may be applied over the source 115 and the detectors 116, 117 to protect detectors such as electromagnetic receivers which are deployed near the outer layer of the tool 30. The detectors 116, 117 may be single axis or multi-axis wire coils each coupled to a respective detector circuit (not shown separately). Thus, detected energy may also be characterized at each of a plurality of distances from the source 115, and thus have different axial resolution. In some examples, two or more different types of well logging instrument, each having a different type of source and different types of corresponding detectors may be included in the same instrument assembly of “string.” Each instrument in the string may have a unique tool response function.

The instrument housing 111 maybe coupled to an armored electrical cable 33 that may be extended into and retracted from the wellbore 32. The wellbore 32 may or may not include metal pipe or casing 16 therein. The cable 33 conducts electrical power to operate the instrument 30 from a surface 31 deployed recording system 70, and signals from the detectors 116, 117 may be processed by suitable circuitry 118 for transmission along the cable 33 to the recording system 70. The recording system 70 may include a computer as will be explained below for analysis of the detected signals as well as devices for recording the signals communicated along the cable 33 from the instrument 30 with respect to depth and/or time.

The well logging tool described above can also be used, for example, in logging-while-drilling (“LWD”) equipment. As shown, for example, in FIG. 2B, a platform and derrick 210 are positioned over a wellbore 212 that may be formed in the Earth by rotary drilling. A drill string 214 may be suspended within the borehole and may include a drill bit 216 attached thereto and rotated by a rotary table 218 (energized by means not shown) which engages a kelly 220 at the upper end of the drill string 214. The drill string 214 is typically suspended from a hook 222 attached to a traveling block (not shown). The kelly 220 may be connected to the hook 222 through a rotary swivel 224 which permits rotation of the drill string 214 relative to the hook 222. Alternatively, the drill string 214 and drill bit 216 may be rotated from the surface by a “top drive” type of drilling rig.

Drilling fluid or mud 226 is contained in a mud pit 228 adjacent to the derrick 210. A pump 230 pumps the drilling fluid 226 into the drill string 214 via a port in the swivel 224 to flow downward (as indicated by the flow arrow 232) through the center of the drill string 214. The drilling fluid exits the drill string via ports in the drill bit 216 and then circulates upward in the annular space between the outside of the drill string 214 and the wall of the wellbore 212, as indicated by the flow arrows 234. The drilling fluid 226 thereby lubricates the bit and carries formation cuttings to the surface of the earth. At the surface, the drilling fluid is returned to the mud pit 228 for recirculation. If desired, a directional drilling assembly (not shown) could also be employed.

A bottom hole assembly (“BHA”) 236 may be mounted within the drill string 214, preferably near the drill bit 216. The BHA 236 may include subassemblies for making measurements, processing and storing information and for communicating with the Earth's surface. Such measurements may correspond to those made using the instrument string explained above with reference to FIG. 1A. The bottom hole assembly is typically located within several drill collar lengths of the drill bit 216. In the illustrated BHA 236, a stabilizer collar section 238 is shown disposed immediately above the drill bit 216, followed in the upward direction by a drill collar section 240, another stabilizer collar section 242 and another drill collar section 244. This arrangement of drill collar sections and stabilizer collar sections is illustrative only, and other arrangements of components in any implementation of the BHA 236 may be used. The need for or desirability of the stabilizer collars will depend on drilling conditions.

In the arrangement shown in FIG. 2B, the components of multi-axial induction well logging instrument may be located in the drill collar section 240 above the stabilizer collar 238. Such components could, if desired, be located closer to or farther from the drill bit 216, such as, for example, in either stabilizer collar section 238 or 242 or the drill collar section 244.

The BHA 236 may also include a telemetry subassembly (not shown) for data and control communication with the Earth's surface. Such telemetry subassembly may be of any suitable type, e.g., a mud pulse (pressure or acoustic) telemetry system, wired drill pipe, etc., which receives output signals from LWD measuring instruments in the BHA 236 (including the one or more radiation detectors) and transmits encoded signals representative of such outputs to the surface where the signals are detected, decoded in a receiver subsystem 246, and applied to a processor 248 and/or a recorder 250. The processor 248 may comprise, for example, a suitably programmed general or special purpose processor. A surface transmitter subsystem 252 may also be provided for establishing downward communication with the bottom hole assembly.

The BHA 236 can also include conventional acquisition and processing electronics (not shown) comprising a microprocessor system (with associated memory, clock and timing circuitry, and interface circuitry) capable of timing the operation of the accelerator and the data measuring sensors, storing data from the measuring sensors, processing the data and storing the results, and coupling any desired portion of the data to the telemetry components for transmission to the surface. The data may also be stored downhole and retrieved at the surface upon removal of the drill string. Power for the LWD instrumentation may be provided by battery or, as known in the art, by a turbine generator disposed in the BHA 236 and powered by the flow of drilling fluid. The LWD instrumentation may also include directional sensors (not shown separately) that make measurements of the geomagnetic orientation or geodetic orientation of the BHA 236 and the gravitational orientation of the BHA 236, both rotationally and axially.

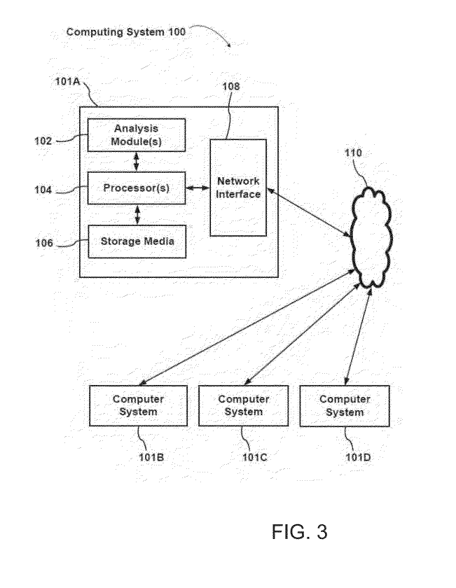

The foregoing computations may be performed on a computer system such as one shown in the processor at 248 in FIG. 2B, or in the surface unit 70 in FIG. 2A. However, any computer or computers may be used to equal effect. FIG. 3 depicts an example computing system 100 in accordance with some embodiments for carrying out example methods such as those explained above with reference to FIG. 1. The computing system 100 can be an individual computer system 101A or an arrangement of distributed computer systems. The computer system 101A includes one or more analysis modules 102 that are configured to perform various tasks according to some embodiments, such as the tasks described above. To perform these various tasks, an analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g. computer systems 101A and 101B may be on a ship underway on the ocean, in a well logging unit disposed proximate a wellbore drilling, while in communication with one or more computer systems such as 101C and/or 101D that are located in one or more data centers on shore, other ships, and/or located in varying countries on different continents).

A processor can include a microprocessor, microcontroller, processor module or subsystem, programmable integrated circuit, programmable gate array, or another control or computing device.

The storage media 106 can be implemented as one or more non-transitory computer-readable or machine-readable storage media. Note that while in the embodiment of FIG. 3 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the embodiment of FIG. 3, and/or computing system 100 may have a different configuration or arrangement of the components depicted in FIG. 3. The various components shown in FIG. 3 may be implemented in hardware, software, or a combination of both hardware and software, including one or more signal processing and/or application specific integrated circuits.

Further, the steps in the methods described above may be implemented by running one or more functional modules in information processing apparatus such as general purpose processors or application specific chips, such as ASICs, FPGAs, PLDs, SOCs, or other appropriate devices. These modules, combinations of these modules, and/or their combination with general hardware are all included within the scope of protection of the invention.

While the specific embodiments described above have been shown by way of example, it will be appreciated that many modifications and other embodiments will come to the mind of one skilled in the art having the benefit of the teachings presented in the foregoing description and the associated drawings. Accordingly, it is understood that various modifications and embodiments are intended to be included within the scope of the appended claims.

What is claimed is:

1. A method for enhancing axial resolution of a well logging instrument, comprising:
in a computer, classifying a formation into a plurality of single well log measurement value zones to generate a squared well log;
in the computer, decomposing a response function of a well logging instrument into a plurality of wavelets;
in the computer, convolving the wavelets with the squared well log to generate a simulated tool response;
in the computer, comparing the simulated tool response to a measured tool response in the formation; and
repeating the decomposing with different coefficients for each wavelet and repeating the convolving until a mismatch between the simulated tool response and the measured tool response falls below a measurement uncertainty of the well logging instrument.

2. The method of claim 1 wherein a type of the wavelets comprise at least one of Biorthogonal, Coiflets, Daubechies, Reverse Biorthogonal, Symlets, Orthogonal and Semi-Orthogonal.

3. The method of claim 1 further comprising:
selecting a number of wavelets, performing the convolving comparing and repeating the decomposition with different coefficients, and convolving; and
decreasing the number of wavelets and repeating performing the convolving comparing and repeating the decomposition with different coefficients, and convolving until the mismatch exceeds the measurement uncertainty.

4. The method of claim 1 wherein a sum of the coefficients is unity.

5. The method of claim 1 wherein the mismatch is determined by minimizing a cost function.

6. The method of claim 5 wherein the minimizing comprises determining a minimum value of a modified Lp norm.

7. The method of claim 6 wherein the modified Lp norm comprises a function having at least two continuous derivatives and having a value asymptotically equal to an absolute value of the mismatch in the power of p that is greater than 0 and at most equal to 1 for values of mismatch exceeding a selected difference from zero and asymptotically equal to a square of the mismatch for values of the mismatch being less than the selected difference.

8. The method of claim 1 wherein the classifying comprises using measurements from an additional well logging instrument having higher axial resolution than the well logging instrument for which the response function is wavelet decomposed.

9. The method of claim 1 wherein the well logging instrument response function is known a priori.

10. The method of claim 1 further comprising generating an initial estimate of the tool response function and determining the tool response function by minimizing a cost function.

11. The method of claim 10 further comprising determining the tool response function in at least one of a formation having known petrophysical properties and a reference formation and calculating a difference between the determined tool response function and a reference tool response function.

12. A method for well logging, comprising:
moving a well logging instrument along a wellbore drilled through subsurface formations;
acquiring measurements of at least one petrophysical parameter using the well logging instrument, the well logging instrument having an axial measurement resolution lower than a number of separate, single petrophysical parameter value zones in the subsurface formations;
in a computer, classifying the subsurface formations into a plurality of single well log measurement value zones to generate a squared well log;
in the computer, decomposing a response function of the well logging instrument into a plurality of wavelets;
in the computer, convolving the wavelets with the squared well log to generate a simulated tool response;
in the computer, comparing the simulated tool response to a measured tool response in the formation; and
repeating the decomposing with different coefficients for each wavelet and repeating the convolving until a mismatch between the simulated tool response and the measured tool response falls below a measurement uncertainty of the well logging instrument.

13. The method of claim 12 wherein a type of the wavelets comprise at least one of Biorthogonal, Coiflets, Daubechies, Reverse Biorthogonal, Symlets, Orthogonal and Semi-Orthgonal.

14. The method of claim 12 further comprising:
selecting a number of wavelets, performing the convolving comparing and repeating the decomposition with different coefficients, and convolving; and
decreasing the number of wavelets and repeating performing the convolving comparing and repeating the decomposition with different coefficients, and convolving until the mismatch exceeds the measurement uncertainty.

15. The method of claim 12 wherein a sum of the coefficients is unity.

16. The method of claim 12 wherein the mismatch is determined by minimizing a cost function.

17. The method of claim 16 wherein the minimizing comprises determining a minimum value of a modified Lp norm.

18. The method of claim 17 wherein the modified Lp norm comprises a function having at least two continuous derivatives and having a value asymptotically equal to an absolute value of the mismatch in the power of p that is greater than 0 and at most 1 for values of mismatch exceeding a selected difference from zero and asymptotically equal to a square of the mismatch for values of the mismatch being less than the selected difference.

19. The method of claim 12 wherein the classifying comprises using measurements from an additional well logging instrument having higher axial resolution than the well logging instrument for which the response function is wavelet decomposed.

20. The method of claim 12 wherein the well logging instrument response function is known a priori.

21. The method of claim 12 further comprising generating an initial estimate of the tool response function and determining the tool response function by minimizing a cost function.

22. The method of claim 21 further comprising determining the tool response function in at least one of a formation having known petrophysical properties and a reference formation and calculating a difference between the determined tool response function and a reference tool response function.
